(19) United States
(12) Patent Application Publication
(10) Pub. No.: US 2025/0049001 A1
(43) Pub. Date: Feb. 13, 2025

(54) AN ANIMAL TRACKING SYSTEM

(71) Applicant: COWEALTHY TEKNOLOJI ANONIM SIRKETI, Gebze, Kocaeli (TR)

(72) Inventors: Yucel SAYKAL, Gebze, Kocaeli (TR); Ismail BICAN, Gebze, Kocaeli (TR); Anil SIRMA, Gebze, Kocaeli (TR); Enes OZKAYA, Gebze, Kocaeli (TR); Mustafa Kemal UYGUN, Gebze, Kocaeli (TR); Ebubekir Siddik CEYLAN, Gebze, Kocaeli (TR)

(21) Appl. No.: 18/721,367

(22) PCT Filed: Dec. 31, 2021
(86) PCT No.: PCT/TR2021/051673

§ 371 Date: Jun. 18, 2024

(30) Foreign Application Priority Data
Dec. 21, 2021 (TR) 2021/020609

(51) Int. Cl. A01K 29/00; A01K 11/00; A61D 13/00; A61D 17/00

(52) U.S. Cl. CPC A01K 29/005; A01K 11/004; A61D 13/00; A61D 17/002; A01K 11/008

(57) ABSTRACT

Disclosed is an animal tracking system having at least one temperature sensor associated with a heat transfer element which has a heat transfer area provided in a manner contacting the ear of livestock, in order to provide tracking of health information and behavior analyses of livestock by the breeder by an electronic ear tag fixed to the ear regions of livestock.

### TECHNICAL FIELD

The present invention relates to an animal tracking system for tracking the condition information of livestock by the breeder. Said animal tracking system comprises a system which provides tracking information like health of livestock, sleep and awake duration, birthing time, rut period, behavior analysis, eating frequency, stand duration by the breeder.

### PRIOR ART

In livestock farming sector, it is substantially important that the specific conditions and specific periods like movements, feeding needs, rut periods, birthing times of poultry and livestock are known by the breeder. The conditions, which are related to the animal health like meeting the food requirements needed to be taken periodically, providing sufficient level of movement, mating of the animal which is in rut period or assisting the animal which is ready for birthing, must be tracked by the breeder and the requirements must be met.

In the present art; by using different technologies, methods have been developed for tracking health parameters and physical movements of livestock by the breeder. Among these methods, systems are used like movement sensor for tracking movements of the animal and positioned at the tail, ear, leg or body region of the animal, and heat sensor, etc. for examining the body temperature of the animal. Besides, the information of number of steps realized by the animal at specific time intervals can be reached by means of a pedometer positioned at a region on the animal.

The body temperature of animals is an important indicator for obtaining information about the health of the animal. The increase in body temperature of livestock shows that the health of the animal gets worsened and there is an infection in its body. This condition can affect the animal individually and can sometimes describe a pandemic disease which covers the whole herd. Thus, body temperatures of animals must be carefully tracked for protecting health of the herd, for increasing efficiency in the amount of product, for early interfering in case of a probable disease and for preventing losses.

The body temperature measurement in livestock is obtained by means of data taken from the heat sensor positioned at one of the regions of the animal like ear, nose, tail or body. In order for operating and information transfer of the heat sensor positioned at a region on the animal, there has to be components like power supply, communication unit, processor together with the heat sensor. When all components are brought together, they are generally embodied in a closed plastic casing. The presence of such a plastic substance between the heat sensor and the livestock may prevent measuring the body temperature of the animal in a correct manner. This may lead to erroneous measurement. The erroneously measured results may lead to delays in treatment of animals or application of faulty treatment.

In the known state of the art, in accordance with some arrangements, infrared heat sensor is used for measuring body temperature of livestock. Infrared heat sensors can realize measurement from close distance without contacting the body of the animal. These arrangements essentially aim at measuring the body temperature behind the ear by means of infrared heat sensor positioned at the ear region of the animal. However, in these arrangements, since the skin of the animal, which stays under the sun, is hotter than the body of the animal, the infrared heat sensor does not measure the body temperature of the animal in a correct manner. Moreover, since the distance between infrared heat sensor and the animal body is not continuously fixed, erroneous measurements may occur.

In the known state of the art, in accordance with some arrangements, there are devices desired to be positioned at the tail region of the animal. In this case, in order to remove the device from the tail of the animal, the tail hair has to be pulled and removed. However, this process may be hurting and disturbing for the animals. Moreover, while this process is being realized, injuries may occur due to instantaneous movements of animals.

The information of movement realized by livestock at specific time intervals is substantially important for the breeder. If a livestock makes less movement when compared with its daily average movement, this may mean that the animal has a disease. In the same manner, if a livestock makes more movement when compared with its daily average movement, this may mean that the animal is in rut period. Therefore, the movements realized by the livestock must be tracked by the breeder.

In the known state of the art, in accordance with some arrangements, movement sensors positioned on the animal are used for tracking movements of the animal. In these arrangements, as a result of movement of the region, where the movement sensor is positioned, moves due to parasites or flies, errors occur in the information taken from the movement sensor.

In the known state of the art, in accordance with some arrangements, GPS module (global positioning system) is utilized which is positioned on the animal for tracking the movements of the livestock. Since the GPS module sets up connection with satellite and determines the position on the earth, its error ratio is substantially high. Moreover, in these arrangements, as the skin of the livestock, which is under sun, is hotter than the body, the infrared heat sensor does not measure the body temperature of the animal in a correct manner. Moreover, GPS modules have high power consumption for realizing signal exchange at long distance. In this case, more energy is needed for feeding GPS module and thus, more area is needed.

In the known state of the art, in accordance with some arrangements, more than one sensor is positioned in more than one region of the livestock. In these arrangements, occupying more than one region on the animal may lead to disturbing of the animal, data intensiveness in wireless communication, cost for producing additional device and moreover decrease in milk efficiency due to the increasing magnetic field density on the animal.

As a result, because of the abovementioned problems, an improvement is required in the related technical field.

### BRIEF DESCRIPTION OF THE INVENTION

The present invention relates to an animal tracking system, for eliminating the abovementioned disadvantages and for bringing new advantages to the related technical field.

An object of the present invention is to provide an animal tracking system which provides tracking of the information like health of livestock, sleep and awake duration, birthing time, rut period, behavior analysis, eating frequency, stand duration by the breeder by means of an electronic ear tag fixed to the ear of the livestock.

In order to realize the abovementioned objects and the objects which are to be deducted from the detailed description below, the present invention is an electronic ear tag in order to be fixed to ears of livestock and comprising at least one temperature sensor, a processor unit configured to receive temperature measurements from said temperature sensor. Accordingly, the subject matter electronic ear tag comprises a heat transfer element which has a heat transfer area provided in a manner contacting the ear of the livestock; a communication unit associated with the processor unit and configured to send data by means of radio waves; said heat transfer area is made of heat conductive material; said temperature sensor is provided in an associated manner to the heat transfer element for measuring the temperature of said heat transfer area. Thus, the body temperature of the livestock is measured by utilizing high heat conductance characteristic of the heat transfer element.

In another possible embodiment of the present invention, said temperature sensor is provided in a manner contacting the heat transfer area. Thus, probable errors, which may occur in measurement of body temperature of livestock received from the temperature sensor which is associated with the heat transfer element, are minimized.

In another possible embodiment of the present invention, said heat transfer element is provided in rod form in order to be passed through an ear hole at the ear of the livestock and in order to be fixed to the ear of the livestock.

In another possible embodiment of the present invention, said heat transfer element is provided in pipe form. Thus, the body temperature of the livestock at the inner part of the ear skin is measured.

In another possible embodiment of the present invention, one end of the heat transfer element and another end of the heat transfer element which is at the opposite side of said end such that the heat transfer area is between these ends are made of heat insulator material. Thus, isolation is provided which prevents heat exchange of the heat transfer element with the outer medium, and the errors, which may occur in measurement of body temperature of the livestock, are prevented.

In another possible embodiment of the present invention, the heat transfer area is provided in whole of the heat transfer element. Thus, the body temperature of the livestock is transferred to the temperature sensor, associated with the heat transfer element, in an efficient manner.

In another possible embodiment of the present invention, said temperature sensor and said processor unit are provided on an electronic board. Thus, the data received from the temperature sensor can be processed in a processor which exists on the electronic board.

In another possible embodiment of the present invention, the electronic ear tag comprises a sensor unit associated with the processor unit and comprising at least one sensor, the processor unit is configured to send the measurements received from at least one of the temperature sensor and the sensor unit by means of the communication unit. Thus, besides the body temperature information received from the temperature sensor associated with the heat transfer element of the livestock, the information of the livestock like movement, acceleration is transferred to the control unit by using other sensors.

In another possible embodiment of the present invention, the processor unit is configured to realize the measurement sending process when it receives predetermined numbers of measurements. Thus, the data received from the temperature sensor and/or the sensor unit is processed in a manner not forming intensiveness in the processor unit, and the processor unit consumes low level of power.

In another possible embodiment of the present invention, said sensor unit comprises a medium temperature sensor for measuring the medium temperature. Thus, the data, received from the temperature sensor associated with the heat transfer element which contacts the body of the livestock, and the data, received from the medium temperature sensor associated with the sensor unit, are compared, and the accuracy of the livestock body temperature is increased.

In another possible embodiment of the present invention, said sensor unit comprises an acceleration sensor. Thus, the information of the movements realized by the livestock at specific time intervals is transferred to the control unit.

In another possible embodiment of the present invention, an isolation layer is provided for encircling said electronic board. Thus, the electronic board is insulated from the parameters like humidity and temperature in the livestock, and the noises (undesired sign/errors) which may occur at the electrical signs are prevented.

In another possible embodiment of the present invention, pluralities of temperature sensors are provided for making measurements from different points of the heat transfer area. Thus, the information received from the temperature sensors associated with the heat transfer element is compared with each other and the body temperature of the livestock is confirmed. Moreover, in case of any error or deterioration which may occur at one of said temperature sensors, the information received from the firm temperature sensor is used, and the usage lifetime of the electronic ear tag is increased.

In another possible embodiment of the present invention, a battery is provided for providing power to electronic components. Thus, the electrical energy, needed by the components like processor unit, temperature sensor, sensor unit which exist in the electronic ear tag, is met.

In another possible embodiment of the present invention, a wireless charge interface is provided in order to provide charging of said battery. Thus, the electronic ear tag is provided to be used for long-duration.

In another possible embodiment of the present invention, the processor unit is configured to operate in sleep mode in cases where no measurement signal comes from the sensors. Thus, in cases where there is no measurement signal received from the sensors by the processor unit, power consumption is minimized.

The present invention is moreover a tracking system for tracking livestock, wherein said tracking system comprises at least one electronic ear tag according to any one of the above mentioned; at least one transceiver unit configured to communicate with the electronic ear tag by means of radio waves; a control unit associated with the transceiver unit for receiving the measurements sent by the electronic ear tag. Thus, the information received from the electronic ear tag fixed to the ear of the livestock is transferred to the control unit in a wireless manner for being tracked by the breeder.

In another possible embodiment of the present invention, the control unit is configured to determine the distance of the electronic ear tag with respect to the transceiver unit in accordance with the power of the signal received by the transceiver unit from the electronic ear tag and to determine a current position in accordance with the determined distance. Thus, the position information of the livestock is transferred to the control unit without needing an additional positioning (GPS) module.

In another possible embodiment of the present invention, at least two transceiver units are provided; the control unit is configured to determine the distance of the electronic ear tag with respect to the transceiver unit in accordance with the power of the signal received by the transceiver unit from the electronic ear tag and to determine a current position related to the electronic ear tag by using the determined distances. Thus, there is no need for an additional positioning (GPS) module for obtaining the position information of the livestock and the processor unit does not consume additional power.

In another possible embodiment of the present invention, said electronic ear tag is according to claim 10; the control unit is configured to generate signal related to body temperature and rut period of the animal, to which the electronic ear tag is fixed, in accordance with the medium temperature measurements received from the medium temperature sensor and the temperature measurements received from the temperature sensor. Thus, the information of the livestock which is in rut period is transferred to the breeder in the shortest time.

In another possible embodiment of the present invention, said electronic ear tag is according to claim 11; the control unit is configured to generate signal related to the rut period, body temperature, movement condition of the animal, to which the electronic ear tag is fixed, in accordance with the medium temperature measurements received from the medium temperature sensor, acceleration measurements received from the acceleration sensor and temperature measurement received from the temperature sensor. Thus, the information of the livestock which is in rut period is transferred to the breeder in the shortest time.

In another possible embodiment of the present invention, the control unit is configured to generate signal by means of machine learning in accordance with the taken measurements. Thus, the accuracy of the information obtained from the electronic ear tag is increased and the breeder is provided to track information with increased accuracy.

### BRIEF DESCRIPTION OF THE FIGURES

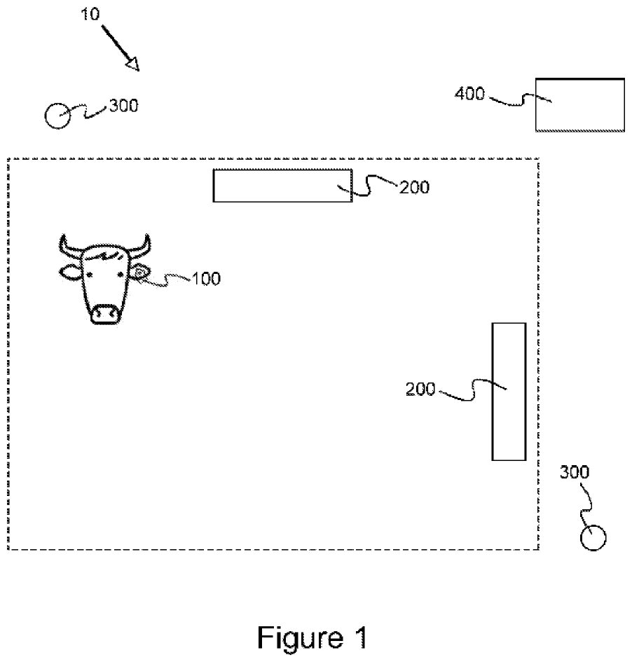

In FIG. 1, a representative view of the animal tracking system is given.

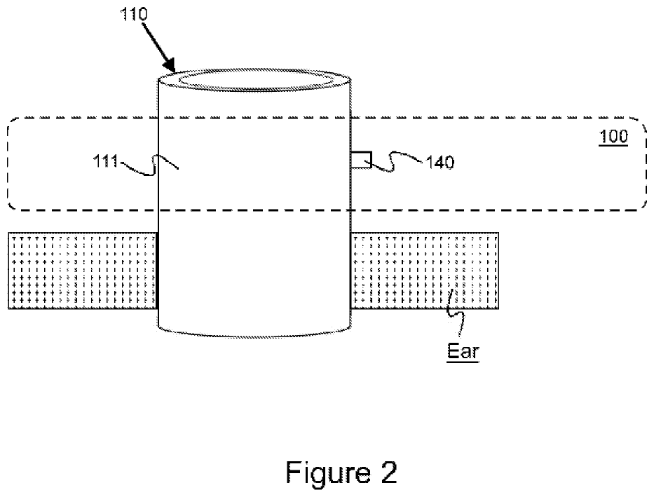

In FIG. 2, a representative view of the heat transfer element is given.

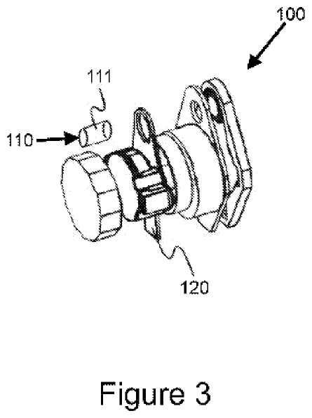

In FIG. 3, a representative view of the electronic ear tag is given.

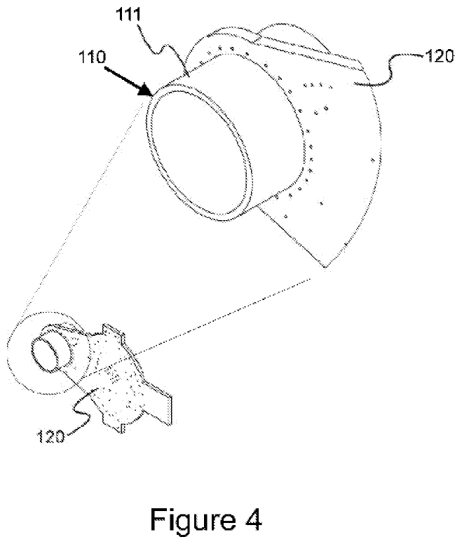

In FIG. 4, a representative view of the relation between the electronic board and the heat transfer element of the electronic ear tag is given.

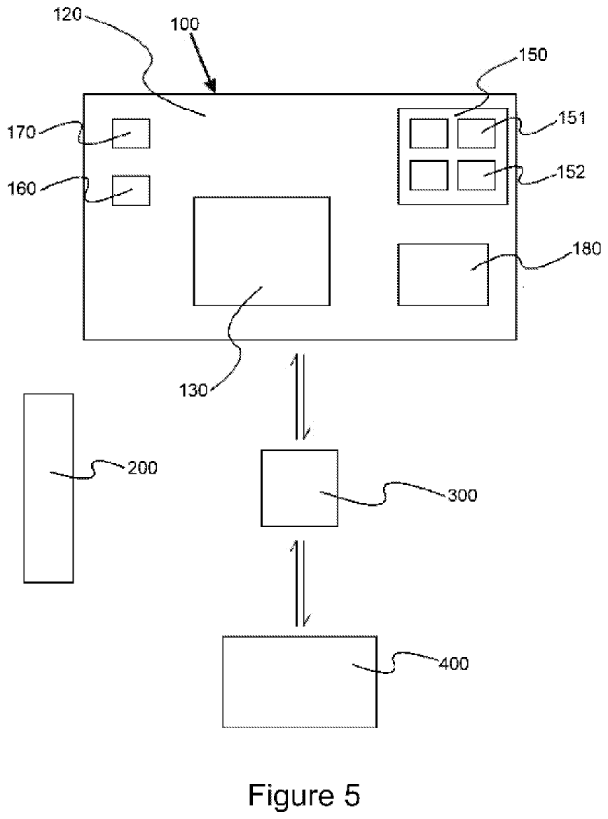

In FIG. 5, a representative view of the schema of the animal tracking system and the electronic ear tag is given.

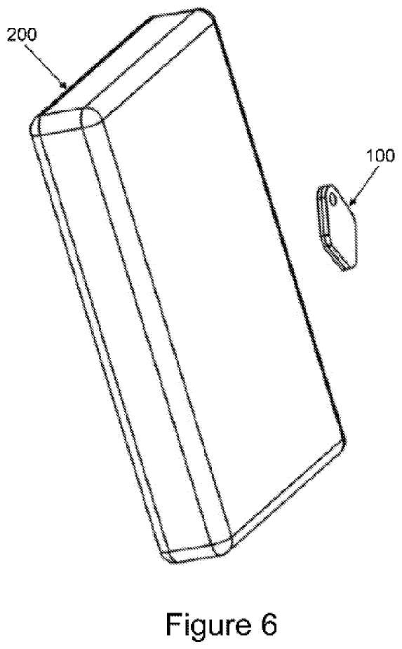

In FIG. 6, a representative view of the charging condition of the charging terminal and the electronic ear tag is given.

### DETAILED DESCRIPTION OF THE INVENTION

In this detailed description, the subject matter animal tracking system (10) is explained with references to examples without forming any restrictive effect only in order to make the subject more understandable.

The present invention relates to an animal tracking system (10) for tracking the condition information of livestock by the breeder.

With reference to FIG. 1, said animal tracking system (10) comprises at least one electronic ear tag (100) embodied to be fixed to the ears of the livestock. With reference to FIG. 3, in accordance with the present embodiment of the invention, the electronic ear tag (100) comprises a circular space for being fixed to the ear region of the livestock. The electronic ear tag (100) is fixed to the ear hole formed at the ear of the livestock. The electronic ear tag (100) comprises at least one temperature sensor (140) for measuring body temperatures of livestock. There is a processor unit (130) configured to receive temperature measurements from said temperature sensor (140). There is a communication unit (180) configured to send data by means of radio waves associated with said processor unit (130).

With reference to FIG. 4, the electronic ear tag (100) comprises a heat transfer element (110) which has a heat transfer area (111) provided in a manner contacting the ear of livestock. Said heat transfer area (111) is made of heat conductive material. With reference to FIG. 2, said heat transfer element (110) is passed through an ear hole which exists at the ear of the livestock and is provided in rod form in a manner fixed to the ear of the livestock. The heat transfer element (110) is moreover provided in pipe form for providing measurement of the body temperature at the inner part of the ear skin of the livestock. In order to prevent heat exchange of the heat transfer element (110) with the outer medium, one end of the heat transfer element (110) and another end of the heat transfer element (110) which is at the opposite side of said end such that the heat transfer area (111) is between these ends are made of heat insulator material. The heat transfer area (111) is provided in whole of the heat transfer element (110). The heat transfer element (110) is provided to be associated with the temperature sensor (140) for measuring the temperature of the heat transfer area (111). Thus, the body temperature of the livestock is efficiently transferred to the temperature sensor (140) associated with the heat transfer element (110). This condition provides measurement of the body temperature of the livestock by utilizing the high heat conductivity of the heat transfer element (110). Pluralities of temperature sensors (140) are provided for making measurement from different positions of the heat transfer area (111). In order to minimize the probable errors in the measurement of the body temperature of the livestock, the temperature sensor (140) and the heat transfer area (111) are positioned in a manner contacting each other. The heat transfer element (110) provides heat transfer to the temperature sensor (140) in an isolated manner from the outer medium by contacting with the lateral surface of the ear hole which exists at the ear of the livestock. Thus, in accordance with the temperature measurements realized through the skin surface or through a section which is close to the skin of the livestock, more precise and more stable measurements are realized.

With reference to FIG. 5, all of the components, provided in the electronic ear tag (100) and which function by means of electrical energy, are provided on an electronic board (120). There is an isolation layer provided in a manner encircling said electronic board (120). Said isolation layer provides insulation of the electronic board (120) against deteriorations which may occur as a result of factors like humidity, temperature, etc. in the farm and provides prevention of the noises (undesired signs/errors) which may occur in electrical signs. The electronic board (120) comprises a sensor unit (150) comprising at least one sensor associated with the processor unit (130). In a possible embodiment of the present invention, said sensor unit (150) comprises a medium temperature sensor (151) for providing measurement of the temperature of the medium. In a possible embodiment of the present invention, the sensor unit (150) moreover comprises a three-dimensional acceleration sensor (152). When the livestock enters the rut period, a reduction occurs in food eating desire. In order to detect these movements, three-axis acceleration sensor (152), which functions by means of MEMS technology, is used. Said acceleration sensor (152) collects 759 acceleration data instantaneously once in each 5 seconds. Thanks to the acceleration sensor (152) of the electronic ear tag (100), the movements made by the livestock are obtained in three-dimensional form, and the appetite and rut of the livestock are detected in a rapid manner. Moreover, while the livestock is in rut period, it can be detected that, the animal lows in a very frequent manner and the stand duration increases, by the three-axis acceleration sensor (152) which functions by means of MEMS technology. Thus, the information, obtained by using magnetometer and gyrometer together, is reached by using a single acceleration sensor (152). Thanks to this, less power and energy consumption of the processor unit (130) is provided, and the battery lifetime is extended. In a possible embodiment of the present invention, one or a number of the sensors of the sensor unit (150) and the temperature sensors (140) associated with the heat transfer element (110) are selected from sensors which function by means of micro electro-mechanical systems (MEMS) technology. This condition provides the electronic ear tag (100) to function in sleep mode and in shut down mode and prevents continuous operation of the electronic ear tag (100). Thus, the usage lifetime of the electronic ear tag (100) is extended.

The electronic ear tag (100) comprises at least one transceiver unit (300) configured to communicate by means of radio waves. In a possible embodiment of the present invention, at least two transceiver units (300) are provided. There is a control unit (400) associated with the transceiver unit (300) in order to receive the measurements sent by the electronic ear tag (100). Said control unit (400) is configured to provide processing of data by means of machine learning method. The transceiver unit (300) is configured such that data exchange is provided between the communication unit (180) and the control unit (400). The signals passing through said transceiver unit (300) are filtered by means of Kalman Filtering method. Thus, the transceiver unit (300) determines the distance of the electronic ear tag (100) with respect to the transceiver unit (300) in accordance with the power of the signal received from the electronic ear tag (100) and determines a current position in accordance with the determined distance. Said position determination process can be realized by means of different developed filtering methods like Kalman filtering. The data transfer between the communication unit (180) and the control unit (400) is realized at sub-1 GHz radio frequency band. Thus, data transfer up to 100 meters can be realized in an uninterrupted manner in the farm. In a preferred embodiment of the present invention, the data transfer between the communication unit (180) and the control unit (400) is realized at frequency of 868 MHZ. In an alternative embodiment of the present invention, the wireless communication between the communication unit (180) and the control unit (400) can be provided by using Zigbee, LoraWan or a more developed communication technology.

In accordance with the present embodiment of the present invention, thanks to said radio frequency technology, remote updating of the electronic ear tag (100) can be provided. Thus, the electronic ear tags (100) can be operated in a firm manner for long years without being removed from the livestock. Moreover, depending on the development of technology, new updates can be easily integrated to the electronic ear tag (100).

There is battery (170) for meeting energy need of components which function by means of electrical energy and which exist in the electronic ear tag (100). Said battery (170) can be a normal battery (170) or a rechargeable battery (170). Both types of batteries (170) can function at small sizes. This condition provides advantage for the electronic ear tag (100) in terms of the location and weight. In the preferred embodiment of the present invention, the battery (170) is a wireless rechargeable battery (170). Said wireless rechargeable battery (170) provides the lifetime of device to be equal to the lifetime of the electronic device and not equal to the lifetime of the battery (170). A wireless charge interface (160) exists for providing charging of said battery (170). Said wireless charge technology is energy harvest technology. Said charging method is RF (radio frequency) based long distance power transfer technology. Thanks to this technology, the electronic ear tag can be charged from a long distance. Said wireless charge technology consists of electromagnetic resonance type charge circuit. Here, the electromagnetic signal is powered by means of high frequency oscillation circuit which exists in the circuit, and by means of the power module, and the electromagnetic signal is sent via an antenna. The transmitter and the antenna have the same resonance frequency. As soon as the data is sent, the receiver and the transmitter (coil/antenna) resonate at a specific frequency and energy exchange takes place. This technology is a technology known in the present art. Thanks to this, more energy is sent within a specific duration. In order to provide charging of said battery (170), there is a wireless charge interface (160). With reference to FIG. 1, the present invention comprises at least one charge terminal (200) positioned ay any region or at a number of regions in the farm in order to provide wireless charging of the battery (170) where the energy needed for the operation of the electronic ear tag (100) is provided. The processor unit (130) provides taking of information from the temperature sensor (140) and from the sensor unit (150) at predetermined time intervals. Except said time intervals, the processor unit (130) is operated in sleep mode. This provides reduction of the area occupied by the battery (170) positioned on the electronic board (120) and provides reduction of power consumption.

The processor unit (130) is configured to take measurement data from at least one of the temperature sensor (140) and the sensor unit (150). The processor unit (130) is configured to function in sleep mode in cases where measurement signal does not come from the sensors. Thus, energy is used in an efficient manner. The processor unit (130) is configured to send the measurements taken from at least one of the temperature sensor (140) and the sensor unit (150) to the control unit (400) by means of the communication unit (180). The control unit (400) is configured to determine the distance of the electronic ear tag (100) with respect to each transceiver unit (300) in accordance with the power of the signal received from the electronic ear tag (100) by the transceiver units (300). The control unit (400) uses the determined distances and provides determination of a current position related to the electronic ear tag (100). The control unit (400) is configured to generate signal related to the body temperature and rut period of the animal, where the electronic ear tag (100) is fixed, in accordance with the medium temperature measurements received from the medium temperature sensor (151) and the temperature measurement received from the temperature sensor (140). The control unit (400) is configured to generate signal related to rut period, body temperature and movement condition of the animal, where the electronic ear tag (100) is fixed, in accordance with the medium temperature measurements received from the medium temperature sensor (151), acceleration measurements received from the acceleration sensor (152) and temperature measurement received from the temperature sensor (140).

In accordance with a preferred embodiment of the present invention, scoring method is used instead of sending raw data obtained in the electronic ear tag (100). In said scoring method, instead of sending all data in raw form, meaning is extracted in accordance with the determined threshold values by means of the algorithm developed on the processor unit (130). Thus, only meaningful data is sent instead of sending all data, and the size of the sent data is reduced and the consumed power is reduced and the operation lifetime of the electronic ear tag (100) is extended.

In accordance with a preferred embodiment of the present invention, the data received from the electronic ear tag (100) is processed with the help of a machine learning algorithm and the information like health of livestock, sleep and awake duration, birthing time, rut period, behavior analysis, eating frequency, stand duration is tracked by the breeder. Said machine learning algorithm can be operated in a server associated with the control unit (400), in a remote external server, in a cloud-based server, etc. Thus, the processor unit provides reduction of energy consumption.

In accordance with a preferred embodiment of the present invention, the information taken from livestock by means of the electronic ear tag (100) is transferred to the breeder at specific time intervals by means of a user terminal via the control unit (400). In a possible embodiment of the present invention, there can be a mobile application provided to a mobile device as said user terminal. In a possible embodiment of the present invention, a web site, a smart application, an SMS, an e-mail, etc. can be used as the mobile application. Thus, the information of livestock can be tracked by the breeder in cases where the breeder is not in the farm.

In accordance with a preferred embodiment of the present invention, sealing characteristic is provided to the structural components of the electronic ear tag (100) by using ultrasonic adhesion method and EPDM rubber gasket. Besides, these processes can be provided also by means of chemical heat binding method.

An exemplary operation scenario of the present invention is hereunder described;

The electronic ear tag (100) is fixed to the ear of a livestock. Body temperature is measured from the ear of the animal, to which the electronic ear tag (100) is fixed, by means of the temperature sensor (140). Moreover, medium temperature is measured in a real-time manner from the medium temperature sensor (151) by means of the sensor unit (150). By comparing the information, received from the medium temperature sensor (151), and the information, received from the temperature sensor (140) associated with the heat transfer element (110), the measurement of the body temperature of the livestock is confirmed. Moreover, the difference between the medium temperature and the body temperature of the livestock is obtained in a precise manner. Thus, rut can be detected in cases of instantaneous heat increase of the livestock, and reluctance and disease can be detected in cases of instantaneous heat decrease of the livestock. The movements of the animal are measured by means of the three-dimensional acceleration sensor (152). The processor unit (130) takes the data measured by means of the temperature sensor (140) and the sensor unit (150). The processor unit (130) provides transfer of the measurement data, received from the temperature sensor (140) and from the sensor unit (150), to the transceiver units (300) by means of the communication unit (180). The transceiver unit (300) provides transfer of the data, received by means of the communication unit (180), to the control unit (400). The control unit (400) provides the received data to be processed by means of machine learning method, and provides determination of the information like the health of the livestock, sleep and awake duration, birthing time, rut period, animal behavior analysis, eating frequency, stand duration. The data is transferred to a server connected to the control unit (400). The breeder can access the data by means of a user terminal connected to the server. The user terminal can be a mobile application provided to a mobile device of the breeder. Thus, the breeder is instantaneously informed about the condition of the animal. This provides regular tracking of the health of the animals and provides prevention of the risky infection conditions which may occur in the animals, and early precaution can be taken for such conditions.

In an exemplary operation scenario of the present invention, the sensors included by the electronic ear tag (100) detect the increase of the movements, lowing movements, stand duration, body temperature of the livestock with approaching rut period, and these are transferred to the processor unit (130). The meaningful data among the data, transferred to the processor unit (130), is selected by means of the scoring method and afterwards, the meaningful data is transferred to the control unit (400) by means of the transceiver unit (300). The breeder tracks the coming data through the control unit (400), electronic e-mail, message or mobile application, and the breeder can realize the required intervention to the livestock in time.

The protection scope of the present invention is set forth in the annexed claims and cannot be restricted to the illustrative disclosures given above, under the detailed description. It is because a person skilled in the relevant art can obviously produce similar embodiments under the light of the foregoing disclosures, without departing from the main principles of the present invention.

### REFERENCE NUMBERS

10 Animal tracking system
100 Electronic ear tag
   110 Heat transfer element
      111 Heat transfer area
   120 Electronic board
   130 Processor unit
   140 Temperature sensor
   150 Sensor unit
      151 Medium temperature sensor
      152 Acceleration sensor
   160 Wireless charge interface
   170 Battery
   180 Communication unit
200 Charge terminal
300 Transceiver unit
400 Control unit

1. An electronic ear tag for fixing to the ears of livestock and, the electronic ear tag comprising:
at least one temperature sensor;
a processor unit configured to receive temperature measurements from said at least one temperature sensor;
a heat transfer element which has a heat transfer area arranged to contact the ear of the livestock, wherein said heat transfer element comprises a rod, and wherein the heat transfer area comprises a heat conductive material and extends around an entire circumference of the heat transfer element;
a communication unit in communication with the processor unit and configured to send data by radio waves; and
wherein said temperature sensor is provided in an associated manner to the heat transfer element for measuring the temperature of said heat transfer area.

2. The electronic ear tag according to claim 1, wherein said temperature sensor contacts the heat transfer area.

3. (canceled)

4. The electronic ear tag according to claim 1, wherein said heat transfer element is hollow.

5. The electronic ear tag according to claim 4, wherein opposing ends of the heat transfer element comprise a heat insulator material, wherein the heat transfer element the heat transfer area is positioned between the opposing ends.

6. (canceled)

7. The electronic ear tag according to claim 1, wherein said temperature sensor and said processor unit are provided on an electronic board.

8. The electronic ear tag according to claim 1, wherein the electronic ear tag comprises a sensor unit associated with the processor unit and comprising at least one sensor, the processor unit is configured to send the measurements received from at least one of the temperature sensor and the sensor unit by means of the communication unit.

9. The electronic ear tag according to claim 8, wherein the processor unit is configured to realize the measurement sending process when it receives predetermined numbers of measurements.

10. The electronic ear tag according to claim 8, wherein said sensor unit comprises a medium temperature sensor for measuring a medium temperature.

11. The electronic ear tag according to claim 10, wherein said sensor unit comprises an acceleration sensor.

12. The electronic ear tag according to claim 7, wherein an isolation layer is provided for encircling said electronic board.

13. The electronic ear tag according to claim 1, wherein pluralities of temperature sensors are provided for making measurements from different points on the heat transfer area.

14. The electronic ear tag according to claim 1, wherein a battery is provided for providing power to electronic components.

15. The electronic ear tag according to claim 14, wherein a wireless charge interface is provided in order to provide charging of said battery.

16. The electronic ear tag according to claim 1, wherein the processor unit is configured to operate in sleep mode in cases where no measurement signal comes from the sensors.

17. An animal tracking system for tracking livestock, wherein said animal tracking system comprises:
at least one electronic ear tag according to claim 1;
at least one transceiver unit configured to communicate with the electronic ear tag by radio waves; and
a control unit associated with the transceiver unit for receiving the measurements sent by the electronic ear tag.

18. The animal tracking system according to claim 17, wherein the control unit is configured to determine the distance of the electronic ear tag with respect to the transceiver unit in accordance with the power of the signal received by the transceiver unit from the electronic ear tag and to determine a current position in accordance with the determined distance.

19. The animal tracking system according to claim 17, wherein at least two transceiver units are provided; the control unit is configured to determine the distance of the electronic ear tag with respect to the transceiver unit in accordance with the power of the signal received by the transceiver unit from the electronic ear tag and to determine a current position related to the electronic ear tag by using the determined distances.

20. The animal tracking system according to claim 16, wherein the electronic ear tag comprises a sensor unit associated with the processor unit and comprising at least one sensor, the processor unit is configured to send the measurements received from at least one of the temperature sensor and the sensor unit by means of the communication unit, wherein said sensor unit comprises a medium temperature sensor for measuring the medium temperature, wherein the control unit is configured to generate signal related to body temperature and rut period of the animal, to which the electronic ear tag is fixed, in accordance with the medium temperature measurements received from the medium temperature sensor and the temperature measurements received from the temperature sensor.

21. The animal tracking system according to claim 16, wherein said electronic ear tag comprises a sensor unit associated with the processor unit and comprising at least one sensor, the processor unit is configured to send the measurements received from at least one of the temperature sensor and the sensor unit by means of the communication unit, wherein said sensor unit comprises a medium temperature sensor for measuring the medium temperature, wherein said sensor unit comprises an acceleration sensor; wherein the control unit is configured to generate signal related to the rut period, body temperature, movement condition of the animal, to which the electronic ear tag is fixed, in accordance with the medium temperature measurements received from the medium temperature sensor, acceleration measurements received from the acceleration sensor and temperature measurement received from the temperature sensor.

22. The animal tracking system according to claim 20, wherein the control unit is configured to generate signal by means of machine learning in accordance with the taken measurements.
